(19) United States
(12) Patent Application Publication
(10) Pub. No.: US 2009/0157596 A1
(43) Pub. Date: Jun. 18, 2009

(54) SYSTEM FOR CONVERTING MESSAGE DATA INTO RELATIONAL TABLE FORMAT

(75) Inventors: TANYA COUCH, SAN JOSE, CA (US); DEBRA L. MAYHEW, MORGAN HILL, CA (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/331,377

(22) Filed: Dec. 9, 2008

Related U.S. Application Data
(63) Continuation of application No. 10/037,659, filed on Jan. 2, 2002.

(51) Int. Cl. G06F 17/30

(52) U.S. Cl. 707/1; 707/100; 707/E17.045; 707/E17.001; 707/E17.005

(57) ABSTRACT

The present invention is directed to a system and computer readable medium for converting messaging data into a relational table format in a database system, wherein the messaging data is within a messaging system. Through aspects of the system and computer readable medium of the present invention, the table function invokes at least one user defined function within the database system. Preferably, the table function is also a user-defined function. The table function can be used within a single SQL statement to access and convert the message data, and to populate directly a relational table. The user is no longer required to perform conversion steps because the conversion is automatically performed by the table function. Moreover, a table view can be created and utilized by a user to select a message and then have the selected message string returned in relational table format.

### CROSS-REFERENCE TO RELATED APPLICATIONS

Under 35 USC §120, this application is a continuation application and claims the benefit of priority to U.S. patent application Ser. No. 10/037,659, filed Jan. 2, 2002, entitled “METHOD AND SYSTEM FOR CONVERTING MESSAGE DATA INTO RELATIONAL TABLE FORMAT”, all of which is incorporated herein by reference.

### FIELD OF THE INVENTION

The present invention relates to messaging functions, and more particularly to building table functions that access messaging data and convert the messaging data into relational table format.

### BACKGROUND OF THE INVENTION

Just as computers have become more and more prevalent in everyday life, networks of linked computers have become important in distributing information amongst computer users. Many computer systems are organized according to a client/server metaphor. In client/server computing, in general, end users are each provided with a desktop computer or terminal known as a “client.” The clients are connected using a network to another computer known as a “server”, because its general function is to serve or fulfill requests submitted by clients. Application programs running on the clients prepare requests and transmit them to the server over the network. A network of computers can be any number of computers that are able to exchange information with one another. The computers may be arranged in any configuration and may be located in the same room or in different countries, so long as there is some way to connect them together (for example, by telephone lines or other communication systems) so they can exchange information. Just as computers may be connected together to make up a network, networks may also be connected together through tools known as bridges and gateways. These tools allow a computer in one network to exchange information with a computer in another network.

In order to account for the fact that different computers connected to such a network may operate using different protocols and/or data formats, and also that different computers may be located in different time zones, asynchronous messaging and queuing software products have been developed. Queuing can be used to implement deferred execution of work. In a system with queuing, a request for work is entered into a queue of requests, and the system defers processing of the request until later, such as when the requesting process has completed the task, process, or transaction that created the request. Queuing has been recognized as an important component of systems that mimic human business processes or work flow.

Messaging and queuing provide a method of inter-program communication which allows programs to send and receive application-specific data without having a direct connection established between them. A message consists of two parts—application data and a message descriptor containing control information. The application data in a message is defined and supplied by the application program which sends the message. There are no constraints on the nature of the data in a message (for example, it could consist of one or more bit strings, character strings, binary integers, etc). In addition to the application data, a message has associated with it some ancillary data. This is information that specifies the properties of the message, and is used by the message queuing service to decide how the message should be processed. Some of this information must be specified by the sending application.

A message queue is a named object in which messages accumulate and from which they are later removed. Each queue belongs to one particular queue manager (which is the system service that provides the message-queuing facilities used by applications), and the queue manager is responsible for the maintenance of that queue. A message queue is not merely a stack: when messages are added to a queue, they are added at the end, and when messages are taken from a queue they are normally removed from the front (although facilities do exist for reading messages in other than FIFO (first-in first-out) order). The physical representation of a message queue depends on the environment but can be a buffer or buffers in main storage, a file or files on disk or other permanent storage device, or both of these. The physical management of message queues is entirely the responsibility of a queue manager, and such details are not made apparent to application programs. Applications can view a message queue simply as a “black box” in which messages accumulate. Applications have access to message queues by using message queuing API (application program interface) calls—obtaining message queuing services by using the message queuing calls to communicate with the queue manager that is installed on the same system as the application (i.e. the local queue manager).

Applications communicate by agreeing to use particular named message queues, sending messages to the specific target queues that the application programs have agreed to read from. The locations of these queues need not be apparent to the applications which send the messages; each application interacts only with its local queue manager, and it is the network of interconnected queue managers that is responsible for moving the messages to the intended queues. In this way, the message queuing software greatly simplifies the level of complexity that is required of the application programs, removing the need for them to implement their own complex communications controls. By way of example, message queuing communication between programs, using batch transfer of messages between adjacent network nodes is provided by the MQSeries family of software products from IBM Corporation, Armonk, N.Y.

While a variety of applications are able to communicate via message queues, of particular interest in today's computing environment are relational database applications. Relational DataBase Management System (RDBMS) software using a Structured Query Language (SQL) interface is well known in the art. The SQL interface has evolved into a standard language for RDBMS software and has been adopted as such by both the American Nationals Standard Organization (ANSI) and the International Standards Organization (ISO). In RDBMS software, all data is externally structured into tables. The SQL interface allows users to formulate relational operations on the tables either interactively, in batch files, or embedded in host languages such as C, COBOL, etc. Operators are provided in SQL that allow the user to manipulate the data, wherein each operator operates on either one or two tables and produces a new table as a result. The power of SQL lies on its ability to link information from multiple tables or views together to perform complex sets of procedures with a single statement.

In patent application Ser. No. 09/731,088, entitled, INTEGRATION OF MESSAGING FUNCTIONS AND DATABASE OPERATIONS, filed Dec. 5, 2000, assigned to IBM Corporation and incorporated herein by reference, message queuing functions are integrated with database operations to combine message queuing communications and database access. User-defined functions (UDFs) are used to build messaging functions that can place a message on a queue, retrieve and read (non-destructively) one or more messages from the queue. These messaging functions are invoked by SQL statements and therefore, messaging data can be accessed using standard SQL operations.

While the above referenced patent application operates well for its intended purpose, i.e., integrating messaging functions and database operations, the messaging data returned to a client is in the same format as it is in the messaging system. Specifically, the returned messaging data is presented to the client as a string of characters or a message string. Generally, in this raw form, the messaging data cannot be used in a database system. For example, the message string cannot be inserted into a table in a database unless it represents a single data column. Thus, the message string must be converted into relational database format, i.e., a row columns for a table. The client must perform several operations on the message string, e.g., parsing, in order to put it in a format for use by the database system.

While not necessarily complicated, converting the message data is tedious and time-consuming. The user would be required to write conversion code within an application program, or create additional UDFs to perform the conversion within a single SQL statement.

Accordingly, a need exists for accessing messaging data and automatically converting that data into relational table format. The method and system should allow the client to customize the table format, to determine the message format, and to preview, i.e., test, the intended result. The method and system also should allow the client to perform database operations on the messaging data in a single SQL statement. The present invention addresses such a need.

### SUMMARY OF THE INVENTION

The present invention is directed to a system and computer readable medium for converting messaging data into a relational table format in a database system, wherein the messaging data is within a messaging system. Through aspects of the system and computer readable medium of the present invention, the table function invokes at least one user defined function within the database system. Preferably, the table function is also a user-defined function. The table function can be used within a single SQL statement to access and convert the message data, and to populate directly a relational table. The user is no longer required to perform conversion steps because the conversion is automatically performed by the table function. Moreover, a table view can be created and utilized by a user to select a message and then have the selected message string returned in relational table format.

### BRIEF DESCRIPTION OF THE DRAWINGS

FIG. 1 illustrates an overall block diagram of a computer system network in accordance with the present invention.

FIG. 2 illustrates a flow chart illustrating a process in accordance with a preferred embodiment of the present invention.

FIG. 3 illustrates a dialog window prompting a user to select a UDF type in accordance with a preferred embodiment of the present invention.

FIG. 4 illustrates a dialog window prompting a user to specify a UDF name in accordance with a preferred embodiment of the present invention.

FIG. 5 illustrates a dialog window prompting a user to specify a database where the UDF will be stored in accordance with a preferred embodiment of the present invention.

FIG. 6 illustrates a dialog window prompting the user to specify the location of a message queue in accordance with a preferred embodiment of the present invention.

FIG. 7 illustrates a dialog window prompting the user to specify how the message data is formatted in accordance with a preferred embodiment of the present invention.

FIG. 8 illustrates a dialog window prompting the user to provide column definitions in accordance with a preferred embodiment of the present invention.

FIG. 8A illustrates an Add Column dialog window in accordance with a preferred embodiment of the present invention.

FIG. 8B illustrates a sample result in accordance with a preferred embodiment of the present invention.

FIG. 9 illustrates a dialog window prompting a user to choose various options in accordance with a preferred embodiment of the present invention.

FIG. 10 illustrates a summary window in accordance with a preferred embodiment of the present invention.

FIG. 10A illustrates a window showing SQL statements making up the table UDF in accordance with a preferred embodiment of the present invention.

### DETAILED DESCRIPTION OF THE INVENTION

The present invention relates to messaging functions, and more particularly to building table functions that access messaging data and convert the messaging data into relational table format. The following description is presented to enable one of ordinary skill in the art to make and use the invention and is provided in the context of a patent application and its requirements. Thus, the present invention is not intended to be limited to the embodiment shown, but is to be accorded the widest scope consistent with the principles and features described herein.

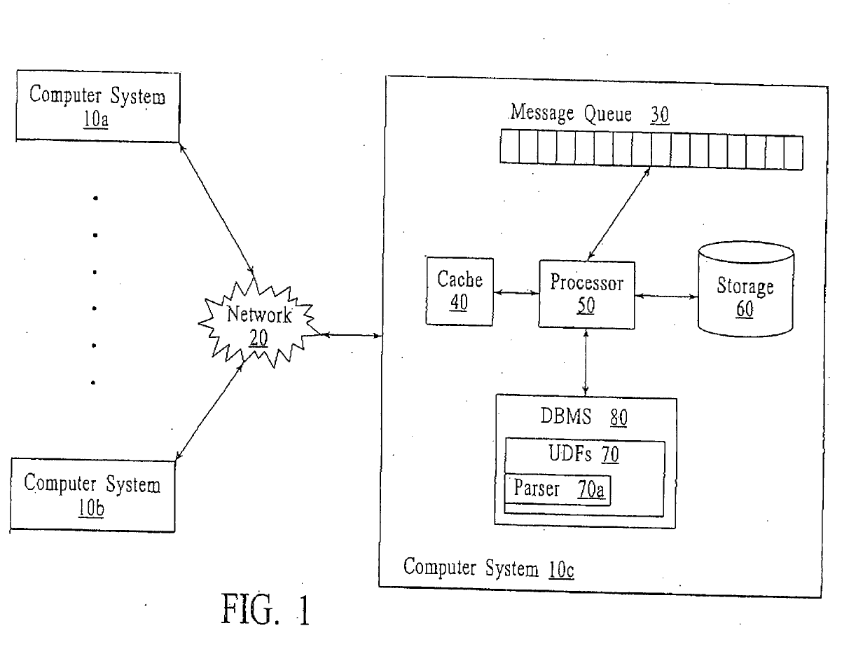

As shown in FIG. 1, a plurality of computer systems 10a, 10b, 10c are interconnected via a network 20 (which could be the public Internet or a private intra-corporate Intranet or wide area network). It should be appreciated that although FIG. 1 illustrates a network of computer systems, this is meant to be exemplary and not restrictive of the type of environment suitable for the aspects of the present invention. Thus, the aspects may also be provided within a single computing system environment.

One of the computer systems (10c) is shown expanded for further illustration. As is shown, computer system 10c has a processor 50 for controlling the overall operation of the computer system 10c, a high speed cache memory 40, a long-term storage device 60 (e.g., hard disk drive), a message queue 30 managed by messaging software (not shown), such as a message queue manager like MQSeries® running on the computer system 10c, and a database program mechanism 80, e.g., an RDBMS system, such as DB2. User defined functions 70 (UDFs) that include the messaging functions are typically part of the database program mechanism 80.

In general, there exists a hierarchy of data processing system resources that includes a message oriented middleware on top of the operating system (using the operating system resources) and underlying the application programs. The messaging software provides support for a number of application programs, which are the business applications run by a system user (e.g. an airline passenger booking facility run by a travel agency). It should be noted that the message queue 30 (when persistence is desired) and database 80 would usually exist in the long-term storage device 60 (or other suitable computer readable medium), but these items have been shown separately in FIG. 1 for functional clarity.

During messaging operations, whenever a new message destined for computer system 10c is received over network 20 from one of the other computer systems (e.g., 10a or 10b), the message is stored in the message queue 30. The data associated with the message is stored in long term storage 60 when persistence is desired. When the processor 50 requests that a particular message be dequeued, that message's associated data is retrieved from storage 60 and provided to processor 50.

In accordance with a preferred embodiment of the present invention, a programming module running on a client computer system (e.g., 10a, 10b) builds a table function that can access the messaging data stored in the message queue 30 and convert that data into specific data types in relational table format. The table function is a UDF that invokes at least one other UDF, which preferably includes a messaging function. Through the messaging function, the table function is able to retrieve (destructively read) or read messaging data. The table function then converts the messaging data into specific data types in relational table format.

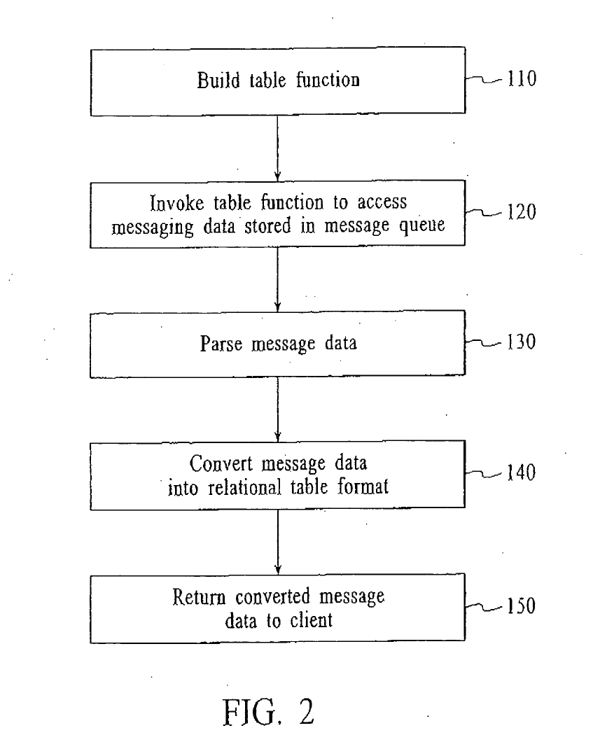

FIG. 2 is a flow chart that illustrates a process in accordance with a preferred embodiment of the present invention. As is shown, the process starts in step 110 by building the table function. When the client invokes the table function, e.g., within an SQL statement, the table function accesses messaging data stored in a particular message queue 30, in step 120, by invoking an appropriate messaging function UDF 70. The messaging data is read or retrieved as a message string, which is then parsed by the table function in step 130.

By parsing the message string, the table function extracts the appropriate data from the message, e.g., application data. For example, the message string can be parsed as a delimited message where each delimited sub-string is treated as data of a relational table column. The message string can also be parsed as a fixed length column string where client specified string positions and lengths designate a sub-string that is to be treated as column data. If the message string is parsed as a delimited message, the table function preferably invokes a parsing UDF 70a, which takes the accessed message string and parses it according to a specified delimiter character, as is well known to those skilled in the art.

The table function then converts the parsed data into relational table format, i.e., a row with columns of desired data types, in step 140. In step 150, the converted message data is returned to the client.

According to a preferred embodiment of the present invention, the table function is custom built pursuant to user specifications. Preferably, the user launches a table function building (TFB) application running on the client computer system. The TFB application provides a graphical user interface (GUI) that collects pertinent information from the user including the desired table formatting. The TFB application includes, but is not limited to, the following function customizations:

Table function type (e.g., a receive (destructively read) or a read function)

Table function name

Specification of the database where the table function will be stored

Location of the messaging system queue

Messaging data format

Column name and data type for each sub-string within the message

Option of creating a table view

Option of saving specifications for future use

Each of the above function customizations will be discussed below.

### Specifying Table Function Type

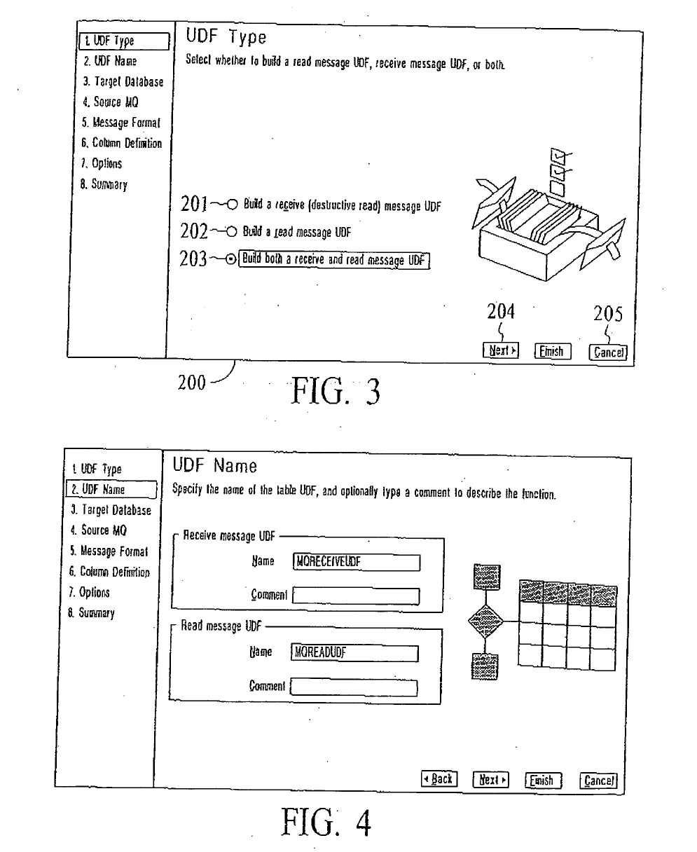

In FIG. 3, a window 200 in accordance with a preferred embodiment of the present invention, the user is allowed to select a type of table function which will be built by the TFB application. As is seen, the user can choose to build a table function that RECEIVEs (i.e., destructively reads) messages 201, or READs (non-destructively) messages 202 from the designated message queue 30. Additionally, the user can choose to build both table functions, one that destructively reads and one that reads messages 203. After the client has chosen the type of table function he or she wishes to build, the user can press the Next button 204 to continue with the building process or to cancel 205 the process altogether.

### Specifying the Table Function Name

In FIG. 4, the user is prompted to provide a name for the table function. If the user has chosen to build RECEIVE and READ table functions, the user is prompted to provide names for both UDFs.

### Designating the Database for Storage

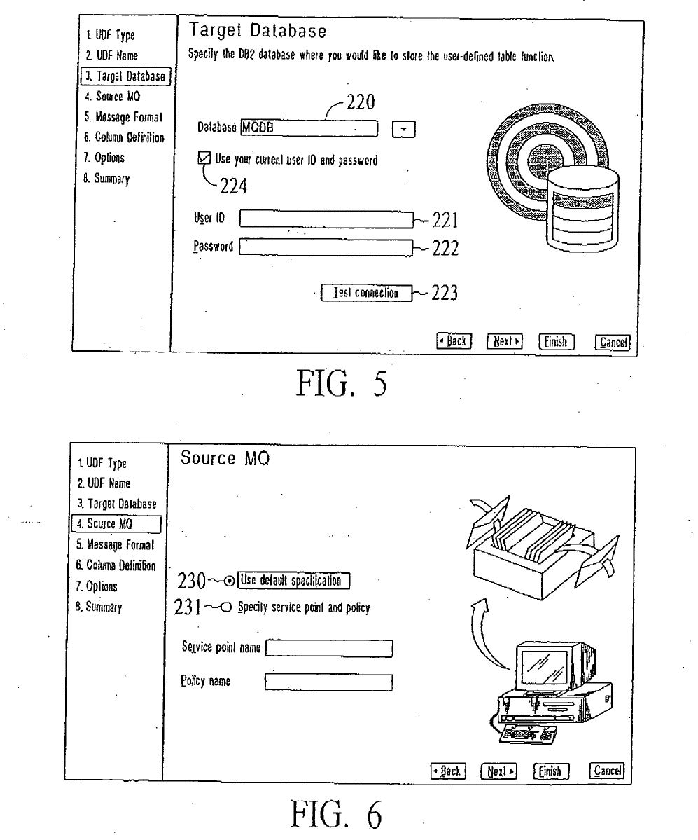

Typically, UDFs are stored in a database system. Thus, in FIG. 5, the user is asked to provide information as to where the table function will be stored by providing a database name 220, User ID 221 and password 222 to access that database. For convenience, the user can designate his or her current User ID and password, if appropriate, by checking a box 224. In a preferred embodiment, a Test Connection button 223 is provided to enable the user to validate the database connection, User ID 221 and password 222.

### Designating the Location of the Desired Message Queue

As indicated above, each computer system 10a, 10b, 10c in a network can maintain its own message queue 30. In fact, a given computer system may be configured to run one or more queue managers each of which may control one or more message queues. Accordingly, the user must provide information regarding the location of the queue on which the message data of interest resides. In FIG. 6, the user is prompted either to specify a specific location, e.g., service point and policy 231 in MQ Series Integrator®, or to select the system default 230.

### Specifying the Format of the Message Data

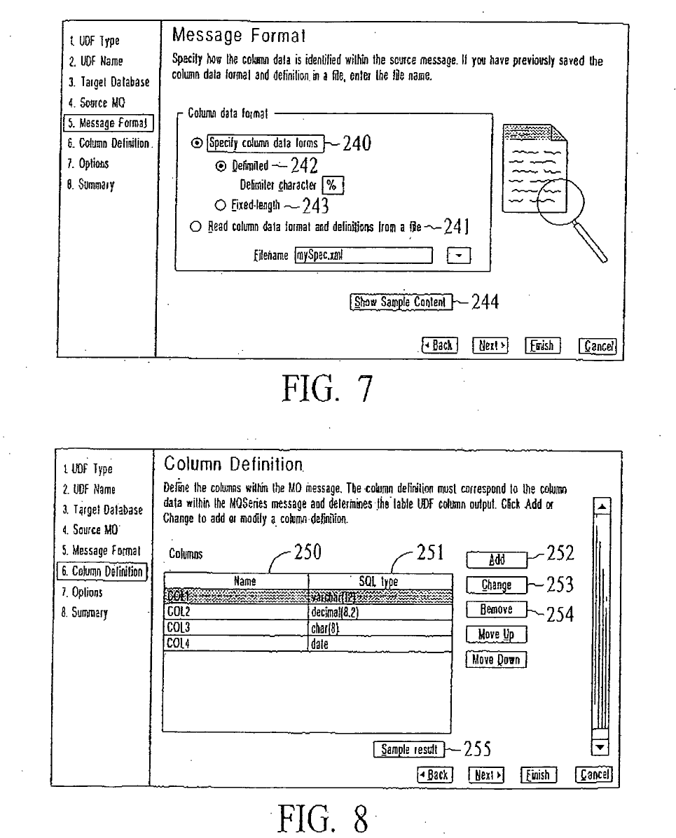

Once the location of the message queue has been specified, the TFB application prompts the user to provide information as to how the message data is formatted. In a preferred embodiment, as is shown in FIG. 7, the user may either specify the format 240 or specify the filename of a file from which formatting specifications can be read 241. If the user chooses the former, the user can choose from two types of formats: (1) delimited 242 and (2) fixed length 243. For delimited formatting 242, the user must specify the character that separates the message data into sub-strings which will be treated as column data. In FIG. 7, therefore, a “%” symbol indicates a beginning and/or end of a sub-string in the message string. For fixed length formatting 243, the user specifies the position and length of each sub-string.

In a preferred embodiment, if the user is not certain of how the message data is formatted, e.g., the user does not know what character delimits the message string, the user can press a Show Sample Content button 244 and a message string from the designated message queue will be displayed to the user. By examining the message string, the user can easily determine the type of formatting for the message data, and can then provide the appropriate formatting information.

### Defining Column Name and Data Type

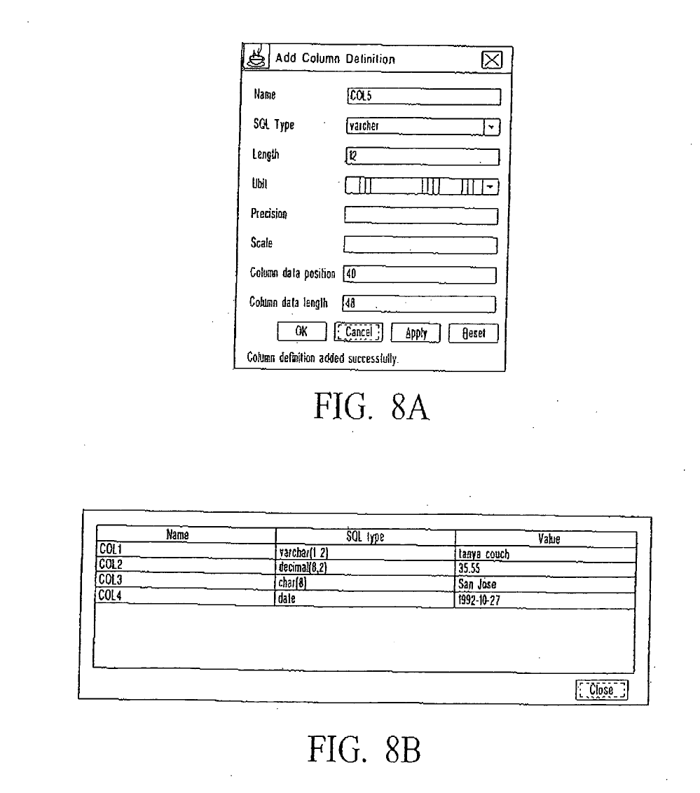

In FIG. 8, the user is prompted to specify a desired column name 250 and data type 251 for each sub-string within the message string that is to be returned as a column. The data type is that into which the user would like to have the corresponding message sub-string returned. Thus, the user must designate a data type that is compatible with the corresponding message sub-string. For instance, the user cannot designate an integer data type for an alpha character sub-string.

In a preferred embodiment, the user defines a new column by pressing an ADD button 252, which launches an Add Column Data dialog window, shown in FIG. 8A. Additional buttons, e.g., CHANGE 253 and REMOVE 254, are provided to edit and delete column definitions, respectively.

In another preferred embodiment, a SAMPLE RESULT button 255 is provided, which when activated, displays to the user the message data converted in accordance with the user's formatting specifications and column definitions. FIG. 8B is an example of what might be displayed to the user after he or she has activated the SAMPLE RESULT button 255. This button allows the user to preview the converted data and to make any corrections in formatting, e.g. correcting data type specifications, before the table function is actually built.

### Option to Create a Table View and to Save the Formatting Specifications

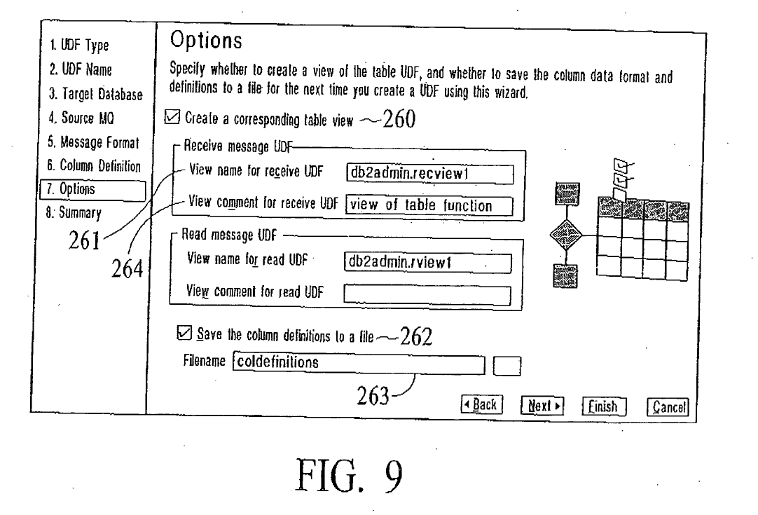

In a preferred embodiment, illustrated in FIG. 9, the user is given the option of creating a view of the table function 260 and/or saving the message data formatting and column definitions to a file 262. If the user chooses to create a table view 260, the user must specify a view name 261 and, optionally, a view comment 264. If the user also chooses to save the column specifications to a file 262, the user specifies a file name 263 to which the specifications will be saved. In this manner, the user can import the same specifications, if appropriate, into a new table function by specifying the filename at the message formatting stage (FIG. 7, item 241), thereby saving time and effort.

The list of customization specifications above is an exemplary list and is not meant to be exhaustive of all such specifications. Other specifications known to those skilled in the art may be appropriate, and those specifications would fall within the scope of the present invention.

After the user has provided the pertinent information discussed above, the TFB application builds the table function according to the user's specifications. In a preferred embodiment, if the message data format is delimited, the TFB will check to see if a parsing UDF 70a exists in the DBMS 80. If it does not, the TFB will build the parsing UDF 70a that will parse the message string after it is retrieved or read by the messaging function. The TFB will then register the newly built parsing UDF 70a to the DBMS 80, where it can be invoked by other table functions created thereafter.

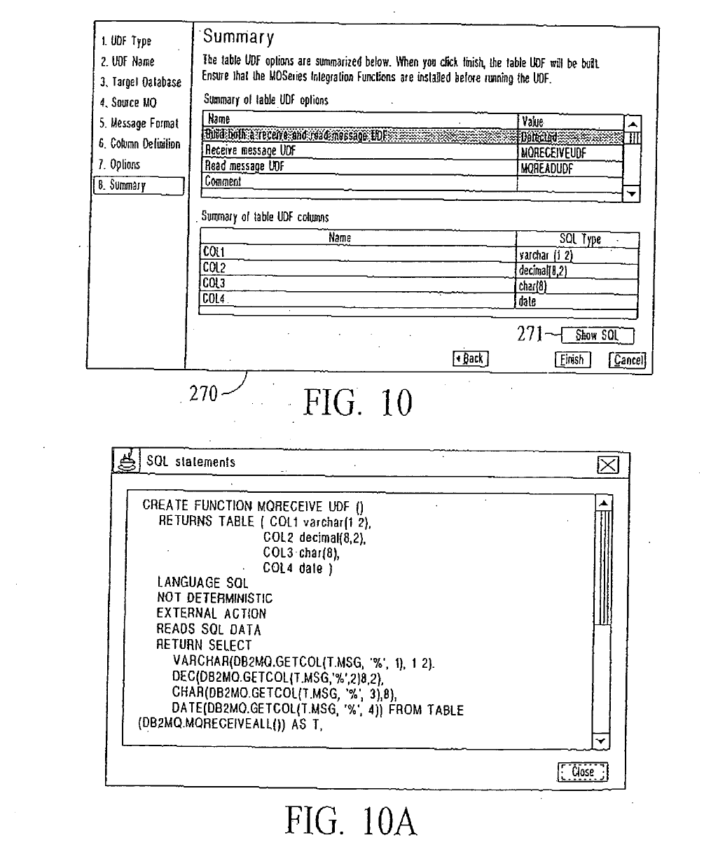

In a preferred embodiment, the TFB application can display a summary window 270 (FIG. 10) to allow the user to review his or her customizations before the table function is built. The summary window 270 includes a SHOW SQL button 271, which when activated, displays the SQL statements making up the table function (see FIG. 10A).

The following example illustrates the operation of a table function built according to the following user specifications.

Message String: “John Jones % San Jose %39% M %36000”

User Specifications:

| | |
|---|---|
| Table function name | GetCustomerData |
| Location of Message Queue | System Default |
| Message Formatting | Delimited by “%” |
| Column Definition (Data Type) | Name (varchar(16)) |
| | City (varchar(20)) |
| | Age (integer) |
| | Sex (char(1)) |
| | Salary (decimal (10.2)) |
| View Creation (Name) | Yes (CustomerDataView) |

Given the specifications above, a table function named GetCustomerData is built. When invoked within an SQL statement, the table function invokes a messaging UDF to retrieve a message from the message queue at a location defined by the default service endpoint. The table function then invokes a parsing UDF 70a to parse the message string as a delimited string, and then the table function converts each substring extracted by the parsing UDF into the specified data types. The table function returns each message on the queue as a five-column row. A table view named CustomerDataView is also built, which through a simple SQL statement, such as “SELECT * FROM CUSTOMERVIEW DATA,” returns the message data as the following row:

| Name | City | Age | Sex | Salary |
|---|---|---|---|---|
| John Doe | San Jose | 39 | M | 36000.00 |

Thus, by utilizing the table view, an end user can select data directly from the table view, without having to invoke the table function directly. In fact, the end user could be completely isolated from the existence of the table function, how it operates, and how it is used. The only information the end user would need is the name of the table view, which the database administrator would typically provide.

Because the table function retrieves and converts the message data into relational table format, the table function can be used within a single SQL statement to access the message data and to populate directly a relational table. The user is no longer required to perform conversion steps, e.g., parsing the message string, because the conversion is automatically performed by the table function. Moreover, the user can utilize the table view to select a message from the table view and then have the selected message string returned in relational table format.

Although the present invention has been described in accordance with the embodiments shown, one of ordinary skill in the art will readily recognize that there could be variations to the embodiments and those variations would be within the spirit and scope of the present invention. For example, although the present invention has been described with reference to a queue-based messaging system, the principles can also be applied with a publish/subscribe-based system, as is well appreciated by those skilled in the art. Accordingly, many modifications may be made by one of ordinary skill in the art without departing from the spirit and scope of the appended claims.

What is claimed is:

1. A computer readable medium containing programming instructions for converting messaging data into a relational table format in a database system, wherein the messaging data is within a messaging system, comprising the programming instructions for:
(a) providing a plurality of table formatting specifications;
(b) utilizing the plurality of table formatting specifications to automatically build and store a table function in the database system;
(c) invoking the table function from within the database system to access the messaging data; and
(d) converting the messaging data by the table function into specific data types according to the plurality of table formatting specifications, wherein the messaging data is transformed into the relational table format.

2. The computer readable medium of claim 1, wherein the table function invokes at least one messaging function within the database system.

3. The computer readable medium of claim 2, wherein the table function and the at least one messaging function are user-defined functions in the database system.

4. The computer readable medium of claim 3, wherein the at least one messaging function retrieves and reads messaging data in the message system.

5. The computer readable medium of claim 1, wherein the providing instruction (a) further includes the instruction for:
(a1) reading the plurality of table formatting specifications from a file.

6. The computer readable medium of claim 1, wherein the providing instruction (a) further includes the instructions for:
(a1) selecting a name and a type for the table function, wherein the type includes one of a retrieve function and a read function;
(a2) specifying where the table function is to be stored; and
(a3) indicating where the messaging data resides.

7. The computer readable medium of claim 6, wherein the specifying instruction (a2) further includes the instructions for:
(a2i) providing a database name and access information; and
(a2ii) allowing the user to validate the access information.

8. The computer readable medium of claim 6, wherein the indicating instruction (a3) further includes the instruction for:
(a3i) providing a service point name for the messaging data.

9. The computer readable medium of claim 6, wherein the indicating instruction (a3) further includes the instruction for:
(a3i) providing a system default endpoint for the messaging data.

10. The computer readable medium of claim 1, wherein the providing instruction (a) further includes the instruction for:
(a1) providing formatting information about the messaging data.

11. The computer readable medium of claim 10, wherein the providing instruction (a1) further includes the instruction for:
(a1i) designating a delimiter character, wherein the delimiter character separates the messaging data into column data.

12. The computer readable medium of claim 11, wherein the converting step (d) further comprising:
(d1) invoking a parser function within the database system for parsing the delimited messaging data.

13. The computer readable medium of claim 12, wherein the invoking step (d1) further includes:
(d1i) checking for the parser function within the database system;
(d1ii) building the parser function if it does not exist within the database system; and
(d1iii) registering the parser function to the database system after it is built.

14. The computer readable medium of claim 10, wherein the providing instruction (a1) further includes the instruction for:
(a1i) specifying a fixed-length format by indicating a position and length of each column.

15. The computer readable medium of claim 10, wherein the providing instruction (a) further includes the instruction for:
(a2) allowing a user to view the messaging data in the messaging system to verify the formatting information provided.

16. The computer readable medium of claim 1, wherein the messaging data comprises a message string, the message string including a plurality of substrings, wherein each substring represents data that is returned as a column in a table.

17. The computer readable medium of claim 16, wherein the providing instruction (a) further includes the instruction for:
(a1) defining a column for each substring of the plurality of substrings in the message string.

18. The computer readable medium of claim 17, wherein the defining instruction (a1) further includes the instructions for:
(a1i) naming each column; and
(a1ii) designating a data type for each column.

19. The computer readable medium of claim 18, wherein the defining instruction (a1) further includes the instruction for:
(a1iii) allowing the user to view the messaging data formatted according to the column definitions provided.

20. The computer readable medium of claim 19, wherein the providing instruction (a) further includes the instruction for:
(a2) building the table function based on the plurality of table formatting specifications collected from the user.

21. The computer readable medium of claim 20, wherein the converting step (d) further includes:
(d1) parsing the message string into the plurality of substrings; and
(d2) converting each substring into the designated data type corresponding to its column.

22. The computer readable medium of claim 1, wherein the providing instruction (a) further includes the instruction for:
(a1) allowing a user to create and name a table view based on the table formatting specifications.

23. The computer readable medium of claim 22, wherein the invoking instruction (c) further includes the instruction for:
(c1) selecting messaging data from the table view.

24. The computer readable medium of claim 1, wherein the providing instruction (a) further includes the instruction for:
(a1) allowing a user to review a summary of the table formatting specifications before building the table function.

25. The computer readable medium of claim 3, wherein the invoking instruction (c) further includes the instruction for:
(c1) integrating the table function within a structured query language statement.

26. The computer readable medium of claim 4 further populating directly a relational table in the database system with the returned messaging data.

27. A system for converting messaging data into a relational table format in a database system, wherein the messaging data is within a messaging system, the system comprising:
a processor;
a table function building application executable by the processor for receiving a plurality of table formatting specifications and for utilizing the plurality of table formatting specifications to automatically build and store a table function in the database system; and
means for invoking the table function from within the database system to access the messaging data;
wherein, once invoked, the table function converts the messaging data into specific data types according to the plurality of table formatting specifications and transforms the messaging data into the relational table format.

28. The system of claim 27, wherein the table function invokes at least one messaging function within the database system.

29. The system of claim 28, wherein the table function and the at least one messaging function are user-defined functions within the database system.

30. The system of claim 29, wherein the at least one messaging function retrieves and reads messaging data in the message system.

31. The system of claim 27, wherein the table function building application includes a means for collecting the table formatting specifications from a user.

32. The system of claim 27, wherein the table function building application includes means for downloading the table formatting specifications from a file.

33. The system of claim 32, wherein the collecting means comprises a graphical user interface, wherein the graphical user interface prompts a user to select a name and a type for the table function, wherein the type includes one of a retrieve function and a read function, to specify where the table function is to be stored, and to indicate where the messaging data resides.

34. The system of claim 33, wherein the graphical user interface further prompts the user to provide formatting information about the messaging data.

35. The system of claim 33, wherein the messaging data comprises a message string, the message string including a plurality of substrings, wherein each substring represents data that is returned as a column in a table.

36. The system of claim 35, wherein the graphical user interface further allows the user to define a column for each substring of the plurality of substrings in the message string.

37. The system of claim 33, wherein the table function building application builds the table function based on the plurality of table formatting specifications collected through the graphical user interface.

38. The system of claim 27, wherein the table function building application allows a user to create and name a table view based on the plurality of table formatting specifications.

39. The system of claim 38, wherein the invoking means includes means for selecting messaging data from the table view.

40. The system of claim 29, wherein the invoking means includes means for integrating the table function within a structured query language statement.

41. A system for generating a customized invocation mechanism, comprising:
an interface for receiving customizations; and
a software module coupled to the interface for building an invocation mechanism based on the customization specifications and storing the invocation mechanism in a database, wherein the invocation mechanism is invokable by the database for accessing data external to the database.

42. The system of claim 41, wherein the invocation mechanism is dynamically generated.

43. The system of claim 41, wherein the invocation mechanism further comprises at least one of the group consisting of: a UDF, a table function, a virtual table, a stored procedure, a trigger, a query statement, and a federated table, and an equivalent of any of the foregoing.

44. The system of claim 41, further comprising means for invoking the invocation mechanism from a database.

45. The system of claim 41, further comprising means for converting data accessed by the invocation mechanism into a format understood by the database.

46. The system of claim 41, wherein the interface further comprising a graphical user interface for receiving function customization specifications.

47. The system of claim 41, wherein the customization specifications further comprise specification of a relational format for nonrelational data accessed by the customized function.

48. The system of claim 41, wherein the interface further comprises means for previewing nonrelational data in relational format based on customization specifications.
